(19) United States
(12) Patent Application Publication
(10) Pub. No.: US 2007/0025570 A1
(43) Pub. Date: Feb. 1, 2007

(54) Condenser microphone

(75) Inventors: Kentaro Yonehara, Shizuoka (JP); Yoshio Imahori, Shizuoka (JP); Hiroshi Fujinami, Shizuoka (JP); Yasunori Tsukuda, Shizuoka (JP); Motoaki Ito, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: STAR MICRONICS CO., LTD.

(21) Appl. No.: 11/496,549

(22) Filed: Aug. 1, 2006

(30) Foreign Application Priority Data
Aug. 1, 2005 (JP) P2005-223232

(51) Int. Cl. H04R 25/00

(52) U.S. Cl. 381/174

(57) ABSTRACT

A condenser microphone includes a condenser part in which a diaphragm is arranged opposed to a back plate, an impedance transformation element which transforms change in electrostatic capacitance of the condenser part into electric impedance, and a circuit which connects the condenser part and the impedance transformation element electrically. Further, the condenser microphone includes a casing which houses therein the condenser part, the impedance transformation element and the circuit, and is formed of an electric insulator. Herein, a conductive layer is provided on the periphery of the casing thereby to give electromagnetic shield ability to the casing.

### BACKGROUND OF THE INVENTION

1. Field of the Invention

This invention relates to a condenser microphone used for a mobile telephone, a video camera, a personal computer and the like.

2. Description of the Related Art

Heretofore, as this type of microphone, there is a condenser microphone which is easy in miniaturization and is disclosed in, for example, JP-A-2002-345092. This condenser microphone is formed by laminating an electric circuit board, a back electrode substrate, a spacer, a diaphragm, a diaphragm supporting frame in order. By the diaphragm and the back electrode substrate, a microphone part is. configured. Further, the whole of the condenser microphone is covered with a cover, which is not shown in JP-A-2002-345092. This cover is made of metal thereby to hold electromagnetic shield ability.

Recently, a silicon microphone manufactured by MEMS (Micro Electro Mechanical System) technology has been also proposed. In the silicon microphone, a microphone part is configured by an electret layer provided for a wafer part and a diaphragm formed opposed to the electret layer by means of the MEMS technology. Also in the conventional silicon microphone, the microphone is covered with a metal cover, or conductive material is filled into a through hole formed in a plate product which becomes a casing, whereby electromagnetic shield ability is held.

### SUMMARY OF THE INVENTION

However, in the condenser microphone which holds the electromagnetic shield ability by the metal cover, since the metal cover is required, there is a problem that the number of parts increases.

Further, in the silicon microphone in which the through hole is formed in the plate product which becomes the casing, since a GND circuit is formed in the product, it is necessary to provide a gate circuit portion of a field effect transistor provided for a wafer part electrically independently of the through hole. Therefore, in this type of silicon microphone, in order to hold the electromagnetic shield ability, it is necessary to put insulating material between a gate circuit portion and a GND circuit, so that there is a problem that the number of parts increases.

An object of this invention is to provide a condenser microphone that can obtain electromagnetic shield ability, can reduce the number of parts for holding the electromagnetic shield ability, and can reduce the cost resultantly.

In order to achieve the object, according to a first aspect of the invention, a condenser microphone includes a condenser part in which a diaphragm is arranged opposed to a back electrode plate, an impedance transformation element which transforms change in electrostatic capacitance of the condenser part into electric impedance, an electric circuit which connects the condenser part and the impedance transformation element electrically, and a housing which houses therein the condenser part, the impedance transformation element and the electric circuit, and is formed of an electric insulator, wherein a conductive part is provided on the periphery of the housing thereby to give electromagnetic shield ability to the housing.

According to a second aspect of the invention, a condenser microphone includes a die provided with a microphone vibrating part which is manufactured by semiconductor process technology, and has a diaphragm and a fixed electrode plate that are arranged opposed to each other, an electric circuit board which mounts the die thereon, and a housing which houses therein the die and an electric circuit connected to the microphone vibrating part electrically, and is formed of an electric insulator, wherein a conductive part is provided on the periphery of the housing thereby to give electromagnetic shield ability to the housing.

According to a third aspect of the invention, the housing is made of one selected from epoxy resin, liquid crystal polymer resin, and ceramics.

According to a fourth aspect of the invention, the conductive part is formed of a conductive adhesive or a conductive paste in the shape of a film.

According to a fifth aspect of the invention, the conductive part is formed of a plated layer.

According to the first aspect of the invention, the electromagnetic shield ability can be obtained, and the number of parts for holding the electromagnetic shield ability can be reduced, so that the cost can be reduced.

According to the second aspect of the invention, the same advantage as that in the first aspect is obtained.

According to the third aspect of the invention, in the first or second aspect, the housing is formed of one selected from epoxy resin, liquid crystal polymer resin, and ceramic, whereby the advantage in the first aspect or the second aspect can be readily realized.

According to the fourth aspect of the invention, in the housing, the conductive part is formed of the conductive adhesive or the conductive paste in the shape of a film, whereby the conductive part can be readily obtained, and the electromagnetic shield ability can be readily obtained.

According to the fifth aspect of the invention, the plated layer is formed in the housing by plating, whereby the conductive part can be readily obtained, and the electromagnetic shield ability can be readily obtained.

### BRIEF DESCRIPTION OF THE DRAWINGS

FIG. 1 is a perspective view of a condenser microphone according to a first embodiment;

FIG. 2 is a longitudinal sectional view of the condenser microphone in FIG. 1;

FIG. 3 is an exploded perspective view of the condenser microphone in FIG. 1;

FIG. 4 is a perspective view showing each member used in manufacture of the condenser microphone;

FIG. 5 is a sectional view of a main portion of the condenser microphone;

FIG. 6 is an explanatory view of a main portion of a spacer forming member;

FIG. 7 is a perspective view of a laminate;

FIG. 8 is a perspective view of the diced laminate;

FIG. 9 is a lateral sectional view of a condenser microphone according to another embodiment; and

FIG. 10 is a longitudinal sectional view of a condenser microphone in another embodiment.

### DETAILED DESCRIPTION OF THE PREFFERED EMBODIMENTS

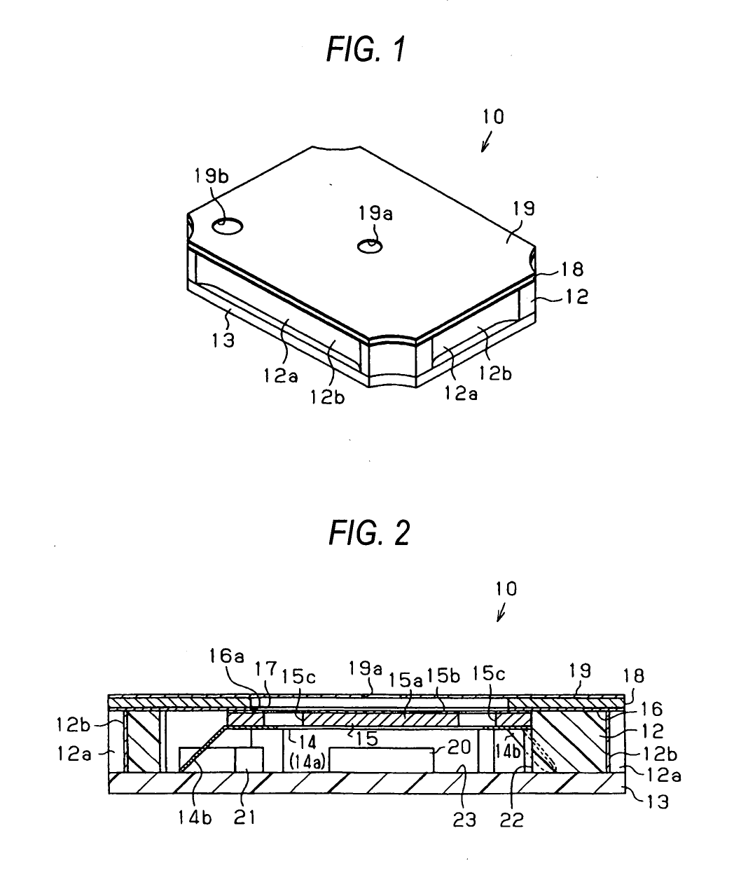

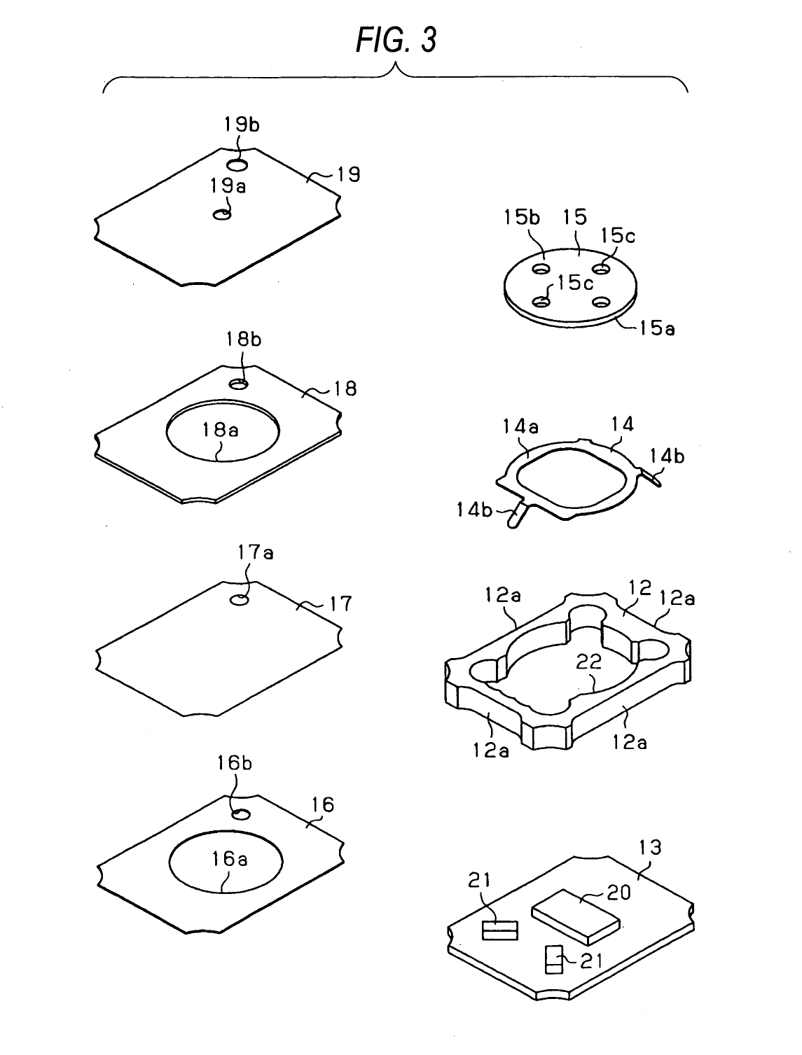

Next, a first embodiment in which this invention is applied to a back electret type condenser microphone will be described with reference to FIGS. 1 to 8.

As shown in FIGS. 1 to 3, a condenser microphone 10 includes a frame-shaped casing 12, an electric circuit board 13, a contact spring 14, a backplate 15, a spacer 16, a diaphragm 17, a diaphragm plate 18 and a cover 19.

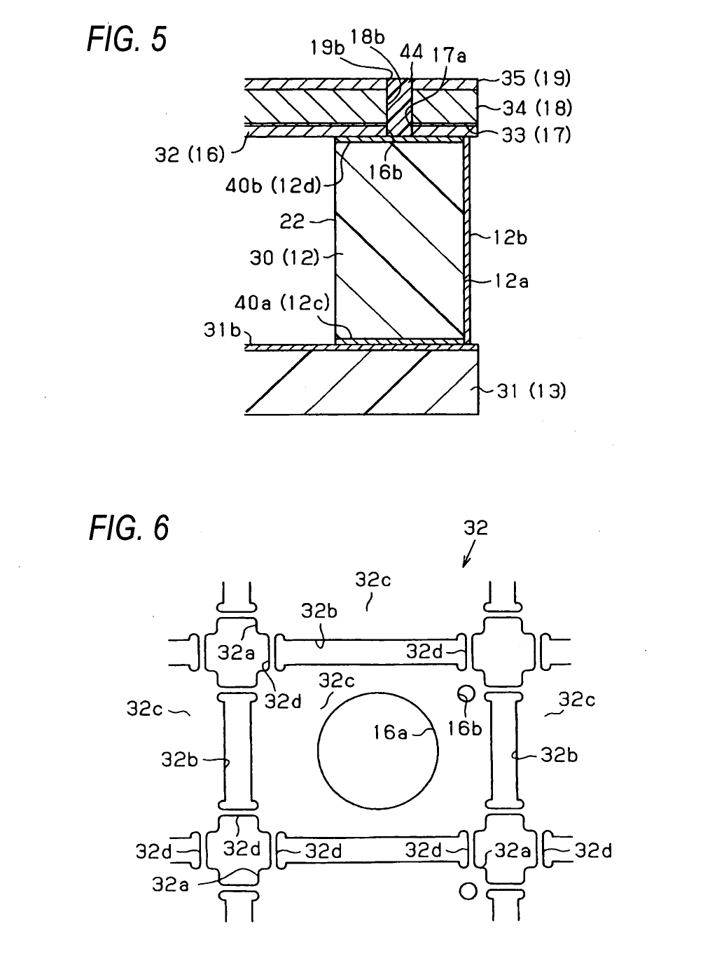

The casing 12 forms a frame of the condenser microphone 10, and includes a nearly columnar hole portion 22 for forming an air chamber 23. The casing 12 is composed of an electric insulator formed of epoxy resin, liquid crystal polymer, ceramics, or the like. In case that the casing 12 is formed of the epoxy resin, epoxy which contains glass is preferable. On the electric circuit board 13, an impedance transformation circuits including a field effect transistor 20 and a condenser 21 is formed. The field effect transistor 20 and the condenser 21 correspond to an impedance transformation element respectively. Further, on the electric circuit board 13, the electric constitution such as an electrode pattern and the like is provided. The electric circuit board 13 is bonded and fixed onto the lower surface of the nearly frame-shaped casing 12 in FIG. 2 with a conductive adhesive, and the impedance transformation circuit is arranged in the hole portion 22. In FIG. 5, a conductive layer 12c is a layer formed on the electric circuit board 13 and the casing 12 with the conductive adhesive.

Further, as shown in FIG. 2, the contact spring 14 is arranged on the electric circuit board 13 in the hole portion 22. The contact spring 14 is formed of a stainless steel plate integrally, and includes a support portion 14a which is nearly ring-shaped and three leg portions 14b extending downward from this support portion 14a. Each leg portion 14b is brought into contact with a not-shown land on the electric circuit board 13, and electrically connected to the impedance transformation circuit through this land. On the upper surface of the support portion 14a, the back plate 15 is supported. The back plate 15 corresponds to a back electrode plate.

The back plate 15 is a disc-shaped plate having the external diameter which is a little smaller than the internal diameter of the hole portion 22 of the casing 12, and the back plate 15 is held in the hole portion 22 movably up and down. The back plate 15 includes a plate body 15a formed of a stainless steelplate, and an electret layer 15b formed of an FEP (Fluorinated Ethylene Propylene) film on the upper surface of this plate body 15a. Polarization processing by corona discharge is applied onto the electret layer 15b. Further, the back plate 15 includes plural through-holes 15c. The plate body 15a of the back plate 15 is electrically connected through the contact spring 14 to the impedance transformation circuit.

Onto the upper surface of the casing 12, the spacer 16 is bonded and fixed with a conductive adhesive. In FIG. 5, a conductive layer 12d is formed on the spacer 16 and the casing 12 with the conductive adhesive. The spacer 16 includes a hole 16a having the internal diameter that is smaller than the internal diameter of the hole portion 22 of the casing 12. With the lower surface of the edge portion of the hole 16a, the upper surface of the peripheral edge portion of the back plate 15 comes into contact. The contact spring 14 is held between the electric circuit board 13 and the back plate 15 in an elastically deformable state for them. On the other hand, the back plate 15 is brought into pressure contact with the lower surface of the inner edge portion of the hole 16a of the spacer 16 by the elastically energizing force of the contact spring 14. Further, in the spacer 16, near the side edge thereof, a through hole 16b is formed. Further, the spacer 16 is formed of a film of resin such as PET (PolyEthylene Terephthalate), or a metal plate.

Onto the upper surface of the spacer 16, the diaphragm 17 is bonded and fixed. The diaphragm 17 is formed of, for example, a PPS (polyphenylene sulfide) film. On the lower surface of the diaphragm 17, an electrode film (not shown) is formed. The diaphragm 17 is a vibrating film. Further, in the diaphragm 17, in the position corresponding to the through hole 16b, a through hole 17a having the same diameter as the diameter of the through hole 16b is formed. By the casing 12, the electric circuit board 13, the spacer 16 and the diaphragm 17, the air chamber 23 divided from the outside is formed (refer to FIG. 2).

Onto the upper surface of the diaphragm 17, the diaphragm plate 18 is bonded and fixed. The diaphragm plate 18 has a hole 18a having the nearly same internal diameter as the internal diameter of the hole 16a of the spacer 16. The diaphragm 17 is held between the spacer 16 and the diaphragm plate 18 in portions except the holes 16a and 18a, and the distance between the diaphragm 17 and the casing 12 is set to the predetermined value (i.e., thickness of the spacer 16) by the spacer 16. Thus, by the back plate 15 and the diaphragm 17, a condenser part having the predetermined impedance is configured. Further, the diaphragm 17 can vibrate at its portion in the hole 18a of the diaphragm plate 18. An electromagnetic film (not shown) of the diaphragm 17 is electrically connected to the impedance transformation circuit through an electromagnetic film (not shown) provided for the spacer 16 and an electromagnetic film provided for the hole portion 22 of the casing 12. Further, since the connection between the electromagnetic film (not shown) of this diaphragm 17 and the impedance transformation circuit is not a main portion of the invention, the detailed description is omitted. Further, in the diaphragm plate 18, in the position corresponding to the through hole 17a, a through hole 18b having the same diameter as the diameter of the through hole 17a is formed.

Onto the upper surface of the diaphragm plate 18, the cover 19 is bonded and fixed. The cover 19 is formed of a metal plate and has conductivity. The cover 19 covers the diaphragm 17 in the hole 18a of the diaphragm 18 from the outside, and includes a sound hole 19a for communicating the outside and the diaphragm 17. The number of the sound holes 19a, though it is one in the embodiment, may be plural. Further, in the cover 19, in the position corresponding to the through hole 18b, a through hole 19b having the same diameter as the diameter of the through hole 18b is formed.

As shown in FIG. 5, into the respective through holes 19b, 18b, 17a, and 16b of the cover 19, the diaphragm plate 18, the diaphragm 17, and the spacer 16, conductive material 44 such as a conductive adhesive or a conductive paste is filled. By the conductive material 44, the conductive layer 12d is electrically connected to the cover 19.

Further, in a recess portion 12a formed on the outer surface of the casing 12, a conductive layer 12b as a conductive part is formed in the shape of a film. The conductive layer 12b is formed by coating the recess part 12a with conductive coating material such as the conductive adhesive or the conductive paste. Through this conductive layer 12b, the conductive layers 12c and 12d are electrically connected to each other. In result, the cover 19 is electrically connected through the conductive layers 12d, 12b and 12c to an electrode pattern 31b that is on the ground side on the electric circuit board 13 (refer to FIG. 5). Further, by the conductive layer 12b that covers a great part of the side surface of the casing 12 and the cover 19 that covers the upside of the casing 12, the electric circuit in the casing 12 is electromagnetically shielded. In the embodiment, by the casing 12 and the electric circuit board 13, a housing is configured.

In the thus constructed condenser microphone 10, by sound waves from a sound source, the diaphragm 17 vibrates through the sound hole 19a of the cover 19. At this time, with the vibration of the diaphragm 17, air moves freely between the upside and the downside of the back plate 15 through the through-holes 15c. Therefore, the vibration of the diaphragm 17 is allowed. Then, the distance between the diaphragm 17 and the back plate 15 changes from the predetermined value, and the impedance of the condenser changes according to a frequency, amplitude, and a waveform of the sound. This change in impedance is transformed into a voltage signal by the impedance transformation circuit and outputted.

A method of manufacturing the condenser microphone 10 will be described briefly.

After plural members have been assembled by lamination, a laminate is divided, whereby the condenser microphone 10 is formed.

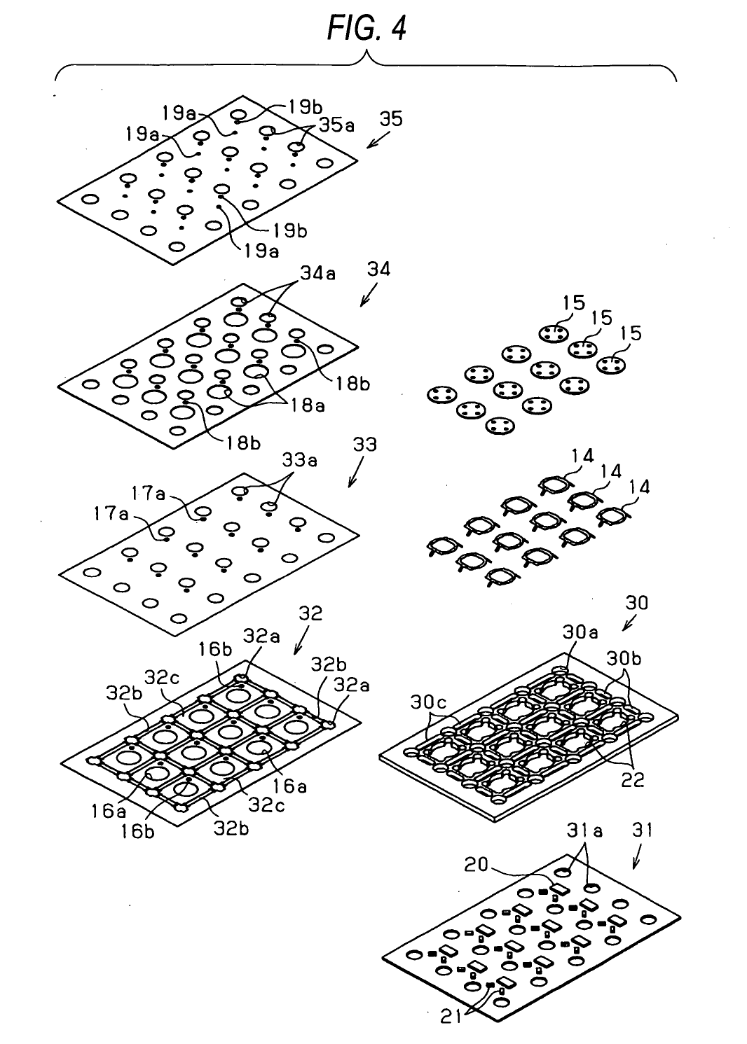

In this manufacturing method, as shown in FIG. 4, using a casing forming member 30, a circuit board forming member 31, a spacer forming member 32, a diaphragm sheet 33, a diaphragm plate forming member 34, a cover forming member 35, the back plates 15 and the contact springs 14, the plural condenser microphones 10 are manufactured.

The casing forming member 30 is a plate material for forming the plural casings 12, and has the plural hole portions 22 formed lengthwise and breadthwise at the predetermined pitch. Further, plural holes 30a, long holes 30b and long holes 30c are provided in the casing forming member 30 lengthwise and breadthwise at the predetermined pitch so as to be located around each hole portion 22. The long hole 30b and the long hole 30c are cut by routing. Alternatively, the long hole 30b and the long hole 30c may be formed by performing drilling work plural times. Into this long hole 30b and the long hole 30c, a conductive adhesive or a conductive paste is filled, or is applied onto the surfaces in their holes. These long hole 30b and long hole 30c, after being diced, become partially the recess portions 12a of the casing 12, and the conductive adhesive or the conductive paste filled into or applied onto the long hole 30b and the long hole 30c forms the conductive layer 12b. The circuit board forming member 31 is an insulating board for forming the plural electric circuit boards 13, and has the plural impedance transformation circuits formed lengthwise and breadthwise at the predetermined pitch. Further, in the circuit board forming plate 31, holes 31a each having the same diameter as the diameter of the hole 30a of the casing forming member 30 are provided in positions corresponding to the holes 30a.

The spacer forming member 32 is a sheet material for forming the plural spacers 16, and has the plural holes 16a and through holes 16b formed lengthwise and breadthwise at the predetermined pitch. Further, in the spacer forming plate 32, plural holes 32a and long holes 32b are provided at the predetermined pitch so as to surround four sides of each hole 16a. In the portion surrounded by the holes 32a and the long holes 32b, an island member 32c (which becomes the spacer 16 after dicing) is formed (refer to FIG. 6). The island members 32c adjacent to each other are coupled by a coupling part 32d which divides the hole 32a and the long hole 32b that are adjacent to each other.

The diaphragm sheet 33 is a sheet material for forming the plural diaphragms 17. Further, in the diaphragm sheet 33, a hole 33a is provided in a position corresponding to each hole 32a of the spacer forming member 32. Further, in the diaphragm sheet 33, a through hole 17a is provided in a position corresponding to each through hole 16b of the spacer forming member 32.

The diaphragm plate forming member 34 is a sheet material for forming the plural diaphragm plates 18, and has the plural holes 18a formed lengthwise and breadthwise at the predetermined pitch. Further, in the diaphragm plate forming member 34, a hole 34a having the same diameter as the diameter of each hole 33a of the diaphragm sheet 33 is provided in a position corresponding to each hole 33a. The cover forming member 35 is a metal plate for forming the plural covers 19, and has sound holes 19a formed lengthwise and breadthwise at the predetermined pitch. Further, in the cover forming member 35, a hole 35a having the same diameter as the diameter of each hole 34a of the diaphragm plate forming member 34 is provided in a position corresponding to each hole 34a. Further, in the cover forming member 35, a through hole 19b is provided in a position corresponding to each through hole 18b of the diaphragm plate forming member 34.

In order to manufacture the condenser microphone 10, the spacer forming member 32 and the diaphragm plate forming member 34 are laminated with the diaphragm sheet 33 between, and the three laminated members are bonded integrally, thereby to provide a diaphragm assembly.

On the other hand, the circuit board forming member 31 is bonded to the casing forming member 30 integrally with the conductive adhesive, thereby to provide a casing assembly. In this casing, as shown in FIG. 5, in the circuit board member 31, in the portion which will become the electric circuit board 13 later by dividing the circuit board member 31, onto the electrode pattern 31b which is on the ground side of the electric circuit of the electric circuit board 13, the side wall lower surface of the portion which will become the casing 12 later by diving the casing forming member 30 is bonded with the conductive adhesive. In FIG. 5, a conductive layer 40a is a layer formed of the conductive adhesive between the circuit board member 31 and the casing forming member 30. Further, in the casing assembly, the inner surfaces in the long holes 30b and 30c are coated with the conductive adhesive or the conductive paste. By this coating, on the inner surfaces (surfaces of the portions which will become the recess portions 12a later by dividing the casing forming member 30) of the long holes 30b and 30c, the conductive layers 12b are formed of the conductive adhesive or the conductive paste.

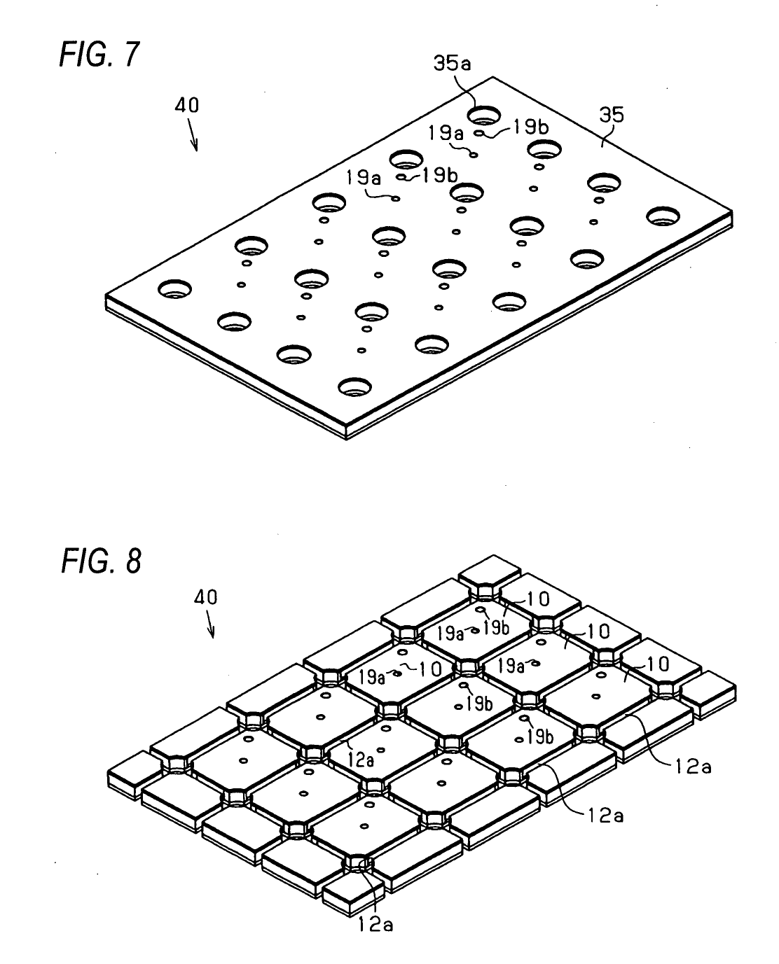

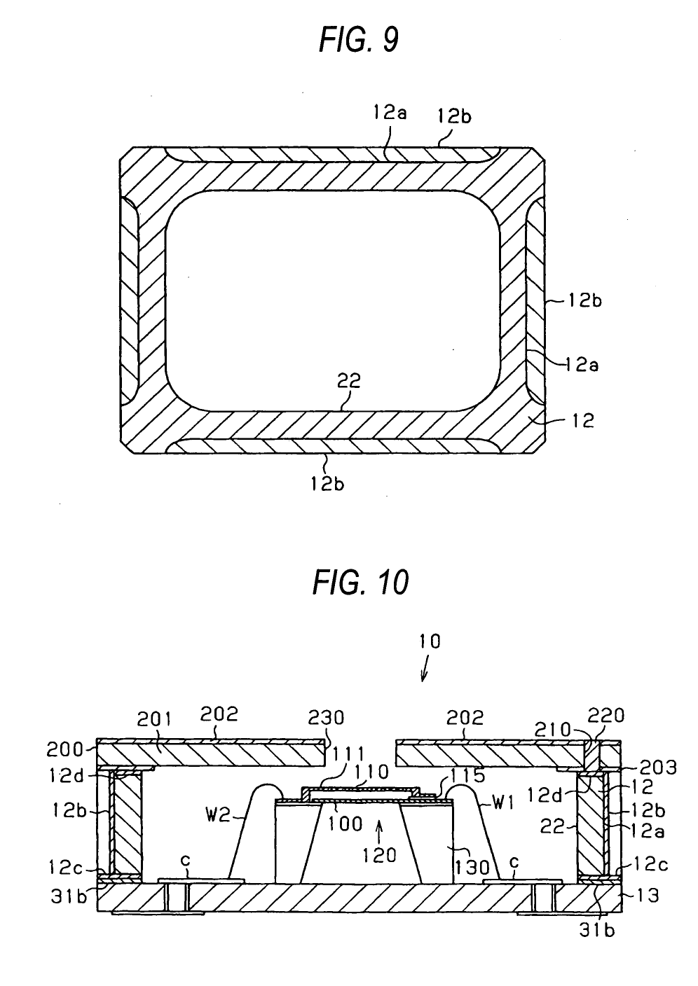

Next, in each hole portion 22 of the casing forming member 30 in this casing assembly, the contact spring 14 and the back plate 15 are built in this order. Next, onto the upper surface of the casing assembly, the diaphragm assembly is bonded integrally with the conductive adhesive, thereby to provide a microphone assembly. In this case, as shown in FIG. 5, in the spacer forming member 32, in the portion which will become the spacer 16 later by dividing the spacer forming member 32, the lower surface of the surrounding edge of its portion is bonded onto the side wall upper surface of the portion which will become the casing 12 later by diving the casing forming member 30 with the conductive adhesive. In FIG. 5, a conductive layer 40b is a layer formed of the conductive adhesive between the spacer forming member 32 and the casing forming member 30. In FIG. 7, a laminate 40 thus formed is shown.

After the laminate 40 has been formed, the conductive material 44 such as the conductive adhesive or the conductive paste is filled into the through holes 19b, 18b, 17a and 16b, as shown in FIG. 5. Next, as shown in FIG. 8, the laminate 40 is diced (cut) using a diamond blade into plural condenser microphones 10.

At this time, in the casing forming member 30 which is formed of epoxy resin, liquid crystal polymer, or ceramics and is the thickest, the holes 30a, and the long holes 30b and 30c which are juxtaposed around the hole portion 22 are divided. Therefore, cutting resistance in dicing is reduced. FIGS. 4, 7 and 8, for convenience of explanation, show a state where 3×4=12 condenser microphones 10 are formed. However, actually, several hundreds of condenser microphones 10 are formed at a time.

The features of the thus configured condenser microphone 10 will be described below.

(1) In the embodiment, by the casing 12 and the electric circuit board 13, the housing is configured, and the conductive layer 12b is provided on the periphery of the casing 12 thereby to provide the electromagnetic shield ability. In result, the condenser microphone 10 can obtain the electromagnetic shield ability. Further, since it is not necessary to arrange the metallic member on the periphery of the casing 12, the number of parts can be reduced, so that the cost can be reduced.

(2) In the embodiment, the casing 12 is formed of the epoxy resin, the liquid crystal polymer resin, the ceramics or the like. In result, the same advantage as that in (1) can be realized. Further, by forming the casing 12 of the epoxy resin, the liquid crystal polymer resin, the ceramics or the like, good heat resistance corresponding to reflow can be obtained.

(3) In the embodiment, the conductive layer 12b is formed of the conductive adhesive or the conductive paste in the shape of a film. Thus, in case that the conductive adhesive or the conductive paste is used, by only applying the conductive adhesive or the conductive paste onto the surface of a coating target, the conductive layer 12b can be formed. Therefore, by the simple work, the conductive layer 12b can be formed. In result, the electromagnetic shield ability can be readily provided for the surrounding surface of the casing 12. Particularly, by forming the conductive layer 12b of the resin-made conductive matter such as the conductive adhesive or the conductive paste, the heat resistance can be obtained more.

### Second Embodiment

Next, a second embodiment will be described with reference to FIG. 10. Components similar or corresponding to those in the first embodiment are denoted by the same reference numerals, and their description is omitted, but only different components will be described.

In a condenser microphone 10 in the second embodiment, the contact spring 14, the back plate 15, the spacer 16, the diaphragm 17, the diaphragm plate 18 and the cover 19 which are the components in the embodiment are omitted. In place of them, a silicon microphone element 120 manufactured from a silicon substrate by semiconductor process technology is provided on an electric circuit board 13.

The silicon microphone element includes a vibrating electrode plate 100 as a diaphragm, and a fixed electrode plate 110 opposed to the vibrating electrode plate 100 with a gap between, which are formed on a die 130. Between the fixed electrode plate 110 and the vibrating electrode plate 100, an insulating film 115 for electrically isolating them from each other is formed. The vibrating electrode plate 100 is electrically connected to a not-shown connection electrode, and connected through the connection electrode and a wire W1 to an electric circuit C on the electric circuit board 13. Further, the fixed electrode 110 is electrically connected to a not-shown connection electrode, and connected through the connection electrode and a wire W2 to an electric circuit C on the electric circuit board 13. In the fixed electrode plate 110, plural through holes 111 are provided. Since the detailed constitution of the vibrating electrode plate 100 and the fixed electrode plate 110 have been known, their detailed description is omitted. By the vibrating electrode plate 100 and the fixed electrode plate 110, a microphone vibrating part is configured. In the thus configured silicon microphone element 120, the vibrating electrode plate 100 vibrates according to sound wave, whereby electrostatic capacitance between the fixed electrode plate 110 and the vibrating electrode plate 100 changes, so that the change in electrostatic capacitance is measured by a not-shown impedance transformation element which is located on the electric circuit board 13, and the sound wave can be transformed into an electric signal.

Further, in the second embodiment, as described before, the diaphragm 17, the diaphragm plate 18, and the cover 19 are omitted, and alternatively, a cover substrate 200 is bonded onto the upper surface of a casing 12 with a conductive adhesive. The cover substrate 200 includes a glass epoxy layer 201 that is an insulating layer, and a metal layer 202 as a conductive layer formed on the glass epoxy layer 201 throughout. Further, on the lower surface of the glass epoxy layer 201, on a portion corresponding to the casing 12, a metal layer 203 as an electrode pattern layer formed with the predetermined pattern is formed (refer to FIG. 10). The metal layers 202 and 203 can be formed of, for example, a copper layer or an aluminum layer. Further, the cover substrate 200 has a penetrating sound hole 230 in its center portion, and a through hole 210 at a part of its portion corresponding to the casing 12. Into the through hole 210, an conductive material 220 such as conductive adhesive or conductive paste is filled. By the constitution similar to that in the first embodiment, the cover substrate 200 is electrically connected to an electrode pattern 31b of the electric circuit board 13 through conductive layers 12d, 12b and 12c formed on the predetermined surfaces of the casing 12 (refer to FIG. 5 in the first embodiment). By such the constitution, also in the second embodiment, by the conductive layer 12b which covers a great part of the peripheral surface of the casing 12 and the cover substrate 200 that covers the upside of the casing 12, an electric circuit C in the casing 12 is electromagnetically shielded. Also in the embodiment, by the electric circuit board 13 and the casing 12, a housing is configured.

The thus configured condenser microphone 10 obtains the working advantage (1) in the first embodiment, and the following advantage.

That is, in the second embodiment, by proving the cover substrate 200, the metal layer 202 is available as a unit for electromagnetic shield. Therefore, it is not necessary to prepare a special member for electromagnetic shield.

Further, the embodiments can be modified as follows.

(1) Though the conductive layer 12b is formed of the conductive adhesive or the conductive paste in the first embodiment, the conductive layer 12b may be formed of a plated layer by metal plating. As metal forming the plated layer, any metal such as copper, aluminum, silver, and the like may be used as long as it has conductivity.

(2) This invention is applicable to a foil-type electret condenser microphone in which an electret function is given to the diaphragm 17 in place of the back plate 15 of the components in the first embodiment.

(3) This invention is applicable to a charge pump type condenser microphone in which the back plate 15 and the diaphragm 17 of the components in the first embodiment are configured so as not to have the electret function, and the back plate 15 and the diaphragm 17 receive a voltage from a charge pump circuit.

(4) Though the conductive layer 12b is applied onto the recess portion 12a of the casing 12 in the first embodiment, as shown in FIG. 4, the conductive adhesive or the conductive paste may be filled into the long holes 30b and 30c of the casing forming member 30. In this case, in case that the laminate 40 is divided later, the conductive layer 12b that is thicker than the conductive layer 12b in the first embodiment can be obtained. Therefore, the electromagnetic shield ability can be increased more than that in the first embodiment.

What is claimed is:

1. A condenser microphone comprising:
a condenser part in which a diaphragm is arranged opposed to a back electrode plate;
an impedance transformation element which transforms change in electrostatic capacitance of the condenser part into electric impedance;
an electric circuit which connects the condenser part and the impedance transformation element electrically; and
a housing which houses therein the condenser part, the impedance transformation element and the electric circuit, and is formed of an electric insulator,
wherein a conductive part is provided on the periphery of the housing thereby to give electromagnetic shield ability to the housing.

2. A condenser microphone comprising:
a die provided with a microphone vibrating part which is manufactured by semiconductor process technology, and has a diaphragm and a fixed electrode plate that are arranged opposed to each other;
an electric circuit board which mounts the die thereon; and
a housing which houses therein the die and an electric circuit connected to the microphone vibrating part electrically, and is formed of an electric insulator,
wherein a conductive part is provided on the periphery of the housing thereby to give electromagnetic shield ability to the housing.

3. The condenser microphone according to claim 1, wherein the housing is made of one selected from epoxy resin, liquid crystal polymer resin, and ceramics.

4. The condenser microphone according to claim 2, wherein the housing is made of one selected from epoxy resin, liquid crystal polymer resin, and ceramics.

5. The condenser microphone according to claim 1, wherein the conductive part is formed of a conductive adhesive or a conductive paste in the shape of a film.

6. The condenser microphone according to claim 2, wherein the conductive part is formed of a conductive adhesive or a conductive paste in the shape of a film.

7. The condenser microphone according to claim 3, wherein the conductive part is formed of a conductive adhesive or a conductive paste in the shape of a film.

8. The condenser microphone according to claim 4, wherein the conductive part is formed of a conductive adhesive or a conductive paste in the shape of a film.

9. The condenser microphone according to claim 1, wherein the conductive part is formed of a plated layer.

10. The condenser microphone according to claim 2, wherein the conductive part is formed of a plated layer.

11. The condenser microphone according to claim 3, wherein the conductive part is formed of a plated layer.

12. The condenser microphone according to claim 4, wherein the conductive part is formed of a plated layer.
